(19) United States
(12) Patent Application Publication
(10) Pub. No.: US 2017/0072967 A1
(43) Pub. Date: Mar. 16, 2017

(54) VEHICLE CONTROL SYSTEM FOR AUTONOMOUSLY GUIDING A VEHICLE

(71) Applicant: Continental Teves AG & Co. oHG, Frankfurt (DE)

(72) Inventors: Gunter Anton Fendt, Schrobenhausen (DE); Ulrich Stählin, Eschborn (DE); Bernhard Schmid, Friedberg (DE); Marc Menzel, Weimar(Lahn) (DE)

(73) Assignees: Continental Teves AG & Co. oHG, Frankfurt (DE); Conti Temic microelectronic GmbH, Nurnberg (DE)

(21) Appl. No.: 15/361,669

(22) Filed: Nov. 28, 2016

Related U.S. Application Data
(63) Continuation of application No. PCT/EP2015/059806, filed on May 5, 2015.

(30) Foreign Application Priority Data
May 27, 2014 (DE) 10 2014 210 147.6

(51) Int. Cl. B60W 50/02; G05D 1/02; B60W 10/18; G05D 1/00; B60W 50/029; B60W 10/20

(52) U.S. Cl. CPC B60W 50/0205; B60W 50/029; B60W 10/20; B60W 10/18; B60W 50/0225; G05D 1/0088; G05D 1/021; B60W 2050/0292; B60W 2420/52; B60W 2050/0215; B60W 2750/40; G05D 2201/0213; B60W 2550/402

(57) ABSTRACT

The invention relates to a vehicle control system for autonomously guiding a vehicle, having a controller for autonomously guiding the vehicle on the basis of a sensor signal of a sensor of the vehicle, wherein the controller is designed to detect a malfunction of the sensor of the vehicle, and a communications interface, which is designed, in response to the detection of the malfunction of the sensor by the controller, to request an auxiliary sensor signal via a communications network and to receive the requested auxiliary sensor signal via the communications network, wherein the controller is designed to guide the vehicle autonomously on the basis of the received auxiliary sensor signal.

### CROSS REFERENCE TO RELATED APPLICATIONS

This U.S. patent application claims the benefit of PCT patent application No. PCT/EP2015/059806, filed May 5, 2015, which claims the benefit of German patent application No. 10 2014 210 147.6, filed May 27, 2014, both of which are hereby incorporated by reference.

### TECHNICAL FIELD

The invention relates to the area of autonomous vehicle guidance.

### BACKGROUND

In the area of automated traffic management autonomous guidance of vehicles is of particular interest. Here, autonomous guidance of vehicles can be semi-autonomous or fully autonomous.

In semi-autonomous guidance, when driving the vehicle, the driver of the vehicle can be assisted in their driving of the vehicle, for example in congestion scenarios. With fully autonomous guidance the vehicle can maneuver itself independently in traffic and thus completely unburden the driver of the vehicle.

For semi-autonomous or fully autonomous guidance of a vehicle, a plurality of sensors of the vehicle is normally used. By using sensor data fusion, the vehicle can thus be guided semi-autonomously or fully autonomously in traffic. In the event of a malfunction of a sensor, however, a situation may arise in which the sensor data fusion can no longer be performed and thus semi-autonomous or fully autonomous guidance of the vehicle is no longer possible.

In this case, guidance of the vehicle is normally handed over to the driver of the vehicle. This is typically associated with a considerable time delay which can be problematic, especially at high vehicle speeds. Alternatively, the vehicle can be independently brought to a halt, wherein in this case the vehicle may constitute an obstacle to other vehicles. This is associated with a loss of efficiency in the area of automated traffic management.

DE 10 2009 050 399 A1 describes a method for controlling the operation of a fully-automated driver assistance system of a motor vehicle designed for independent vehicle guidance.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

It is therefore the object of the present invention to provide an efficient concept for autonomously guiding a vehicle.

A vehicle control system is provided, which allows autonomous guidance of the vehicle using sensors of the vehicle and is designed to detect a malfunction of a sensor of the vehicle. In response to this the vehicle control system can request and receive an auxiliary sensor signal via a communications network. This ensures that autonomous guidance of the vehicle in the event of a malfunction of a sensor of the vehicle is possible using the auxiliary sensor signal. According to an embodiment the auxiliary sensor signal is provided by a guidance vehicle and transmitted to the vehicle control system. This allows virtual towing of the vehicle by the guidance vehicle to be implemented.

According to a first aspect, a vehicle control system for autonomously guiding a vehicle, having a controller for autonomously guiding the vehicle on the basis of a sensor signal of a sensor of the vehicle, wherein the controller is designed to detect a malfunction of the sensor of the vehicle, and a communications interface, which is designed, in response to the detection of the malfunction of the sensor by the controller, to request an auxiliary sensor signal via a communications network and to receive the requested auxiliary sensor signal via the communications network, wherein the controller is designed to autonomously guide the vehicle on the basis of the received auxiliary sensor signal. Thus being able to implement an efficient concept for autonomously guiding the vehicle.

The vehicle control system can be part of a driver assistance system of the vehicle or form a driver assistance system of the vehicle. The vehicle control system can be connected with an actuator of the vehicle for longitudinal guidance and/or lateral guidance of the vehicle. The vehicle can, by way of example, be an automobile or a truck.

The sensor of the vehicle can be a RADAR (Radio Detection and Ranging) sensor, a LIDAR (Light Detection and Ranging) sensor, an ultrasound sensor, or an imaging camera for detecting an environment of the vehicle. The malfunction of the sensor can be a partial defect or a full defect of the sensor.

The communications network can be an ITS-G5 (Intelligent Transport Systems G5) communications network, a mobile radio communications network, a WLAN (Wireless Local Area Network) communications network, a Bluetooth communications network or a UWB (Ultra Wide Band) communications network. The communications network can be formed by the Internet or be connected to the Internet.

The communications network can further comprise a back-end server. A communications link via the communications network can be established via the back-end server.

The autonomous guidance of the vehicle can be based on a sensor data fusion. The autonomous guidance of the vehicle can further be based on a Simultaneous Localization and Mapping (SLAM) approach. The autonomous guidance of the vehicle can be performed using the sensor signal or the auxiliary sensor signal.

According to one embodiment the controller has a sensor interface for receiving the sensor signal and is designed to detect the malfunction of the sensor of the vehicle in the absence of receipt of the sensor signal. Thus the advantage is achieved that the malfunction of the sensor can be efficiently detected.

The malfunction of the sensor can further be detected in the absence of receipt of the sensor signal for a predetermined length of time. The predetermined length of time can by way of example be 1 millisecond, 5 milliseconds, 10 milliseconds, 50 milliseconds, 100 milliseconds, 500 milliseconds, 1 second, 5 seconds or 10 seconds.

According to one embodiment the communications interface is designed to request the auxiliary sensor signal via the communications network from a guidance vehicle and to receive the auxiliary sensor signal via the communications network from the guidance vehicle. Thus the advantage is achieved that a guidance vehicle can be used for providing the auxiliary sensor signal.

The guidance vehicle can, by way of example, be an automobile or a truck. The guidance vehicle can comprise an auxiliary sensor for providing the auxiliary sensor signal. The auxiliary sensor can detect an environment of the vehicle and/or of the guidance vehicle. The guidance vehicle can further have an additional communications interface for communication with the vehicle via the communications network. The guidance vehicle can be guided manually, semi-autonomously or fully autonomously.

According to one embodiment, the controller is designed to detect a plurality of geographical locations of a plurality of vehicles in the environment of the vehicle and to select a guidance vehicle from the plurality of vehicles on the basis of the plurality of geographical locations. Thus, a guidance vehicle can be efficiently selected.

The plurality of geographical locations can comprise geographical degrees of longitude and/or geographical degrees of latitude. The guidance vehicle can be selected so that it is the guidance vehicle with the shortest distance to the vehicle. The guidance vehicle can further be selected so that the guidance vehicle is travelling immediately in front of the vehicle.

According to one embodiment the communications interface is designed to receive a plurality of location indicators via the communications network, wherein the plurality of location indicators indicate the plurality of geographical locations of the plurality of vehicles, and the controller is designed to detect the plurality of geographical locations on the basis of the plurality of location indicators. Thus, the plurality of geographical locations can be efficiently determined.

The plurality of location indicators can comprise Decentralized Environmental Notification Message (DENM) communication messages or Cooperative Awareness Message (CAM) communication messages.

According to one embodiment the communications interface is designed to receive a driving route indicator from a guidance vehicle via the communications network, wherein the driving route indicator indicates a driving route of the guidance vehicle, and the controller is designed to autonomously determine a driving route of the vehicle on the basis of the driving route indicator. Thus, the vehicle can efficiently follow the guidance vehicle.

The driving route indicator can indicate a course and/or a destination point of the driving route of the guidance vehicle. The driving route of the vehicle can be autonomously determined on the basis of the course and/or the destination point of the driving route of the guidance vehicle.

According to one embodiment the communications interface is designed to receive a speed indicator or an acceleration indicator of a guidance vehicle from a guidance vehicle via the communications network, and the controller is designed to autonomously guide the vehicle on the basis of the speed indicator or the acceleration indicator. Thus, the driving dynamics of the guidance vehicle can be taken into account in the autonomous guidance of the vehicle.

The speed indicator can indicate an instantaneous speed of the guidance vehicle. The acceleration indicator can indicate an instantaneous acceleration of the guidance vehicle.

According to one embodiment, the controller is designed to detect a severity of the malfunction of the sensor, in order to obtain a malfunction severity indicator, and the communications interface is designed to transmit the malfunction severity indicator via the communications network together with the request for the auxiliary sensor signal. Thus, the auxiliary sensor signal can be provided as a function of the severity of the malfunction of the sensor.

The malfunction severity indicator can be discrete. The malfunction indicator can, by way of example, indicate a minor malfunction, a moderate malfunction or a serious malfunction of the sensor.

According to one embodiment the communications interface is designed to establish an authenticated and/or encrypted communications link via the communications network, in particular between the vehicle and a guidance vehicle. Thus, the auxiliary sensor signal can be efficiently transmitted.

Establishing the authenticated and/or encrypted communications link can, by way of example, be performed on the basis of the AutoSAR standard, Version 4.2.1. A communication via the communications link can be performed using a Forward Error Correction (FEC).

According to one embodiment the vehicle comprises an additional sensor, and the controller is designed to autonomously guide the vehicle on the basis of an additional sensor signal of the additional sensor of the vehicle. Thus, the vehicle can be autonomously guided using the auxiliary sensor signal and the additional sensor signal.

The autonomous guidance of the vehicle can be based on a sensor data fusion. The autonomous guidance of the vehicle can further be based on a Simultaneous Localization and Mapping (SLAM) approach. To this end, the auxiliary sensor signal and the additional sensor signal can be processed together.

According to an embodiment, the controller is designed to generate a malfunction indicator indicating the malfunction of the sensor, in response to the detection of the malfunction of the sensor, and the communications interface is designed to transmit the malfunction indicator via the communications network to a back-end server. Thus, a malfunction of a sensor of the vehicle can be reported to a back-end server.

The malfunction indicator can comprise a Decentralized Environmental Notification Message (DENM) communication message or a Cooperative Awareness Message (CAM) communication message. The back-end server can comprise an intelligent transportation system server or an emergency services control center server.

According to one embodiment the sensor signal or the auxiliary sensor signal comprises a RADAR sensor signal, a LIDAR sensor signal, an ultrasound sensor signal, or an image camera sensor signal. Thus, the environment of the vehicle can be efficiently detected and indicated.

The sensor signal can be provided by the sensor of the vehicle. The auxiliary sensor signal can be provided by a sensor of a guidance vehicle.

According to one embodiment the communications interface comprises an ITS-G5 communications interface, a mobile radio communications interface, a WLAN communications interface, a Bluetooth communications interface, or a UWB communications interface. Thus, communication via the communications network can be efficiently implemented.

The ITS-G5 communications interface can be created on the basis of the ETSI EN 302 665 standard. The mobile radio communications interface can comprise a GSM (Global System for Mobile Communications) communications interface, a UMTS (Universal Mobile Telecommunications System) communications interface, or an LTE (Long Term Evolution) communications interface.

The WLAN communications interface can be based on the IEEE 802.11 standard. The Bluetooth communications interface can be based on the IEEE 802.15.1 standard. The UWB communications interface can be based on the IEEE 802.15.4a standard.

According to a second aspect, the invention relates to a method for autonomously guiding a vehicle, with autonomous guidance of the vehicle on the basis of a sensor signal of a sensor of the vehicle, detection of a malfunction of the sensor of the vehicle, in response to the detection of the malfunction of the sensor requesting an auxiliary sensor signal via a communications network, receiving the requested auxiliary sensor signal via the communications network, and autonomously guiding the vehicle on the basis of the received auxiliary sensor signal. Thus, an efficient concept for autonomously guiding the vehicle can be implemented.

The above method can be carried out by means of the vehicle control system. Additional features of the method are directly indicated by the functionality of the vehicle control system.

According to one embodiment, the auxiliary sensor signal is requested via the communications network from a guidance vehicle, and the auxiliary sensor signal is received via the communications network from the guidance vehicle. Thus, a guidance vehicle for providing the auxiliary sensor signal can be used.

According to a third aspect, a computer program with a program code for performing the method, when the computer program is executed on a computer. Thus the advantage is achieved that the method can be automated and performed repeatedly.

The computer program can be executed by the vehicle control system. The vehicle control system can be programmatically configured to do so.

The invention can be implemented by software and/or hardware.

Other objects, features and characteristics of the present invention, as well as the methods of operation and the functions of the related elements of the structure, the combination of parts and economics of manufacture will become more apparent upon consideration of the following detailed description and appended claims with reference to the accompanying drawings, all of which form a part of this specification. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

Additional exemplary embodiments are described in more detail with reference to the attached figures, in which:

FIG. 1 shows a diagram of a vehicle control system for autonomously guiding a vehicle according to an embodiment;

FIG. 2 shows a diagram of a method for autonomously guiding a vehicle according to an embodiment; and

FIG. 3 shows a diagram of a communication system for autonomously guiding a vehicle using a guidance vehicle according to an embodiment.

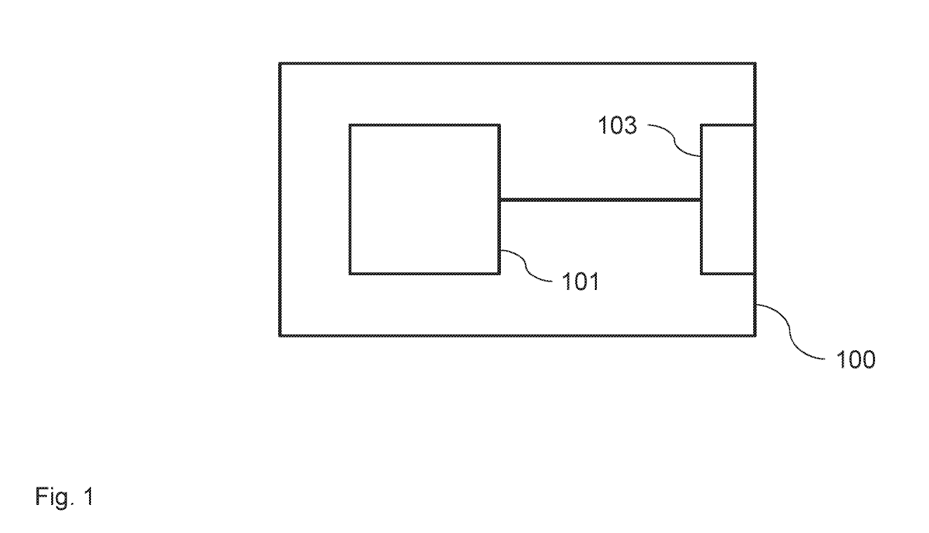

FIG. 1 shows a diagram of a vehicle control system 100 for autonomously guiding a vehicle according to an embodiment.

### DETAILED DESCRIPTION

The vehicle control system 100 comprises a controller 101 for autonomously guiding the vehicle on the basis of a sensor signal of a sensor of the vehicle, wherein the controller is designed to detect a malfunction of the sensor of the vehicle, and a communications interface 103, which is designed, in response to the detection of the malfunction of the sensor by the controller 101, to request an auxiliary sensor signal via a communications network and to receive the requested auxiliary sensor signal via the communications network, wherein the controller 101 is designed to autonomously guide the vehicle on the basis of the received auxiliary sensor signal.

The vehicle control system 100 can be part of a driver assistance system of the vehicle or form a driver assistance system of the vehicle. The vehicle control system 100 can be connected with an actuator of the vehicle for longitudinal guidance and/or lateral guidance of the vehicle. The vehicle can, by way of example, be an automobile or a truck.

The sensor of the vehicle can comprise a RADAR (Radio Detection and Ranging) sensor, a LIDAR (Light Detection and Ranging) sensor, an ultrasound sensor, or an image camera for detecting an environment of the vehicle. The malfunction of the sensor can be a partial defect or a full defect of the sensor.

The communications network can be an ITS-G5 (Intelligent Transport Systems G5) communications network, a mobile radio communications network, a WLAN (Wireless Local Area Network) communications network, a Bluetooth communications network or a UWB (Ultra Wide Band) communications network. The communications network can be formed by the Internet or be connected to the Internet.

The communications network can further comprise a back-end server. A communications link via the communications network can be established via the back-end server.

The autonomous guidance of the vehicle can be based on a sensor data fusion. The autonomous guidance of the vehicle can further be based on a Simultaneous Localization and Mapping (SLAM) approach. The autonomous guidance of the vehicle can be performed using the sensor signal or the auxiliary sensor signal.

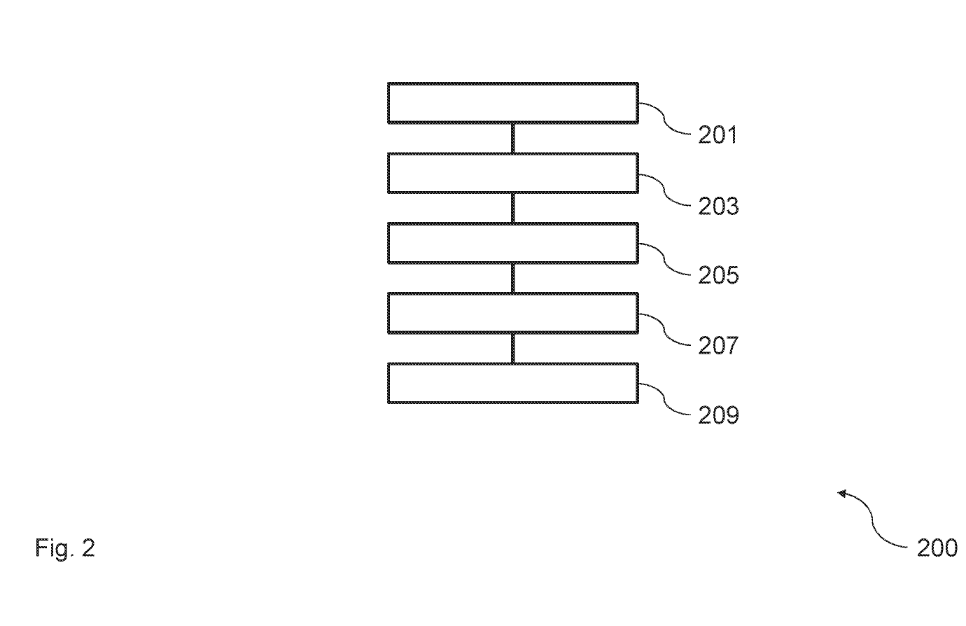

FIG. 2 shows a diagram of a method 200 for autonomously guiding a vehicle according to an embodiment.

The method 200 comprises autonomous guidance 201 of the vehicle on the basis of a sensor signal of a sensor of the vehicle, detection 203 of a malfunction of the sensor of the vehicle, in response to the detection of the malfunction of the sensor, requesting 205 of an auxiliary sensor signal via a communications network, receiving 207 of the requested auxiliary sensor signal via the communications network, and autonomous guidance 209 of the vehicle on the basis of the received auxiliary sensor signal.

The method 200 can be carried out by means of the vehicle control system 100. Additional features of the method 200 are directly indicated by the functionality of the vehicle control system 100.

The vehicle control system 100 can execute a computer program with a program code for performing the method 200. The vehicle control system 100 can be programmatically configured to do so.

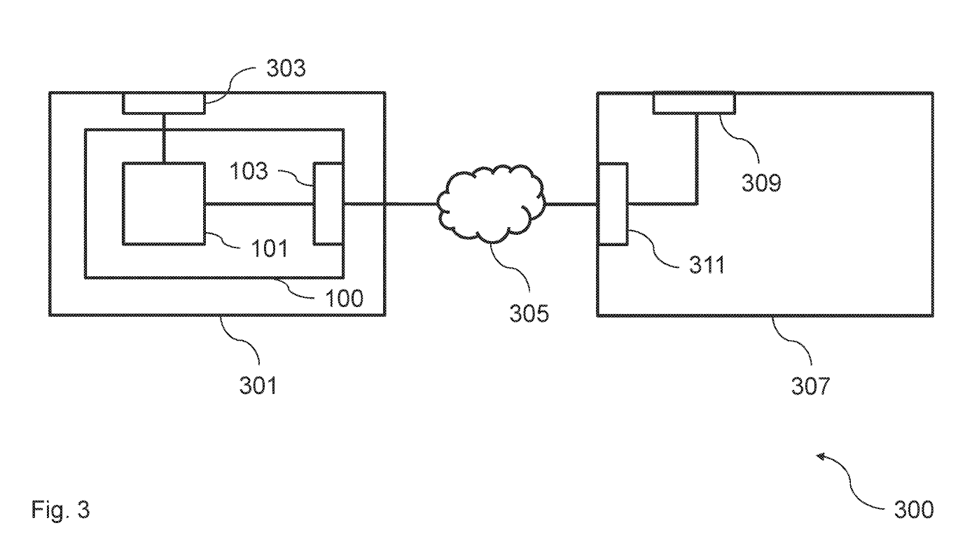

FIG. 3 shows a diagram of a communication system 300 for autonomously guiding a vehicle 301 using a guidance vehicle 307 according to an embodiment. The vehicle 301 is connected via a communications network 305 with the guidance vehicle 307.

The vehicle 301 comprises a vehicle control system 100 for autonomously guiding the vehicle 301 and a sensor 303. The vehicle control system 100 comprises a controller 101 for autonomously guiding the vehicle 301 on the basis of a sensor signal of the sensor 303 of the vehicle 301, wherein the controller 101 is designed to detect a malfunction of the sensor 303 of the vehicle 301, and a communications interface 103, which is designed, in response to the detection of the malfunction of the sensor 303 by the controller 101, to request an auxiliary sensor signal via the communications network 305 and to receive the requested auxiliary sensor signal via the communications network 305, wherein the controller 101 is designed to autonomously guide the vehicle 301 on the basis of the received auxiliary sensor signal.

The guidance vehicle 307 comprises an auxiliary sensor 309 and an additional communications interface 311. The auxiliary sensor 309 is designed to provide the auxiliary sensor signal. The additional communications interface 311 is designed to transmit the auxiliary sensor signal from the guidance vehicle 307 to the vehicle 301 for the autonomous guidance of the vehicle 301.

The autonomous guidance of the vehicle 301 can be based on a sensor data fusion. The autonomous guidance of the vehicle 301 can further be based on a Simultaneous Localization and Mapping (SLAM) approach. The autonomous guidance of the vehicle 301 can be performed using the sensor signal or the auxiliary sensor signal.

Autonomously guiding a vehicle using a guidance vehicle or a third vehicle is available as a fallback level. The autonomous vehicle guidance can be implemented by means of a vehicle control system as a driver assistance system.

Generally, two types of vehicle guidance can be distinguished: a semi-autonomous vehicle guidance and a fully autonomous vehicle guidance. In semi-autonomous guidance, a driver of a vehicle can be assisted by a vehicle control system, if the traffic conditions allow, such as for example in a congestion scenario, in which the vehicle is moving forwards at low speed, or in a stop-go scenario. In fully autonomous vehicle guidance the driver of a vehicle can be assisted by a vehicle control system, wherein the vehicle can be maneuvered in the traffic without the driver having to do anything.

Vehicle control systems for semi-autonomous vehicle guidance can have various designs. In this case they are primarily intended to make the driving of a vehicle easier for the driver, and to ensure assisted maneuvering when this is necessary, for example in accident situations and/or accident scenarios.

By way of example, a method for operating a vehicle control system can be used in which in the event of an unavoidable collision, the system, by means of a target trajectory, can lessen or avoid the consequences of a second collision, by performing longitudinal guidance interventions and/or lateral guidance interventions, in order to achieve implementation or attainment of the target trajectory.

A method for adjusting a controller parameter of a vehicle control system can further be used, in which an adjustment can take place as a function of an ascertained driving state. Thus inappropriate, exaggerated, and/or over-reactive actions of a driver can be counteracted.

A method for influencing the movement of a vehicle can further be used, in which if an accident is detected the driving state of the vehicle can be influenced independently of the driver.

A method for securely halting the vehicle can further be used, in which a check is made on whether there is an emergency situation, wherein if an emergency situation is detected the vehicle control system guides the vehicle to a side of the highway.

A method for operating a vehicle control system or a congestion assistant system can further be used, in which an unburdening phase during an autonomous journey can be optimally prolonged in a congestion situation.

In regards to fully autonomous vehicle guidance, the design of vehicle control systems can similarly vary.

By way of example, a method for controlling the operation of a fully automated vehicle control system of a motor vehicle, designed for independent vehicle guidance can be used. Here a plausibility monitoring module exclusively considering at least one sensor and/or one vehicle system can determine a plausibility, and check the EGO data and/or contextual data describing the current operating state of the vehicle to see if an error case not covered by the functionality of the vehicle control system exists. If an error case exists, a driver intervention for transfer of the vehicle to a defined state based on an action plan can be carried out, which can comprise a time sequence of controller commands.

A method for a vehicle control system for automated longitudinal and/or lateral guidance or control of a vehicle can further be used, wherein a control task for longitudinal and/or lateral guidance or control of the vehicle can be handed over by a driver of the vehicle to the vehicle control system.

A method for controlling the operation of a fully automatic vehicle control system of a motor vehicle designed for independent vehicle guidance can further be used, wherein a transfer of the vehicle to a defined state, by way of example halting of the vehicle, is sought if the driver of the vehicle does not comply with a vehicle guidance takeover request.

Here the vehicle control system can comprise at least an environment-detecting, by way of example image-generating, sensor, by way of example an image camera, wherein the sensor signals or sensor data gathered can be processed and/or integrated with additional environmental sensor signals or sensor data using sensor data fusion. The sensor data fusion can be performed by means of a sensor data merger.

In methods and systems for vehicle guidance it is of particular interest which state is achieved and/or what response is given, if there is a malfunction in the sensor data fusion or a malfunction in an environmental sensor, in particular an image-generating sensor.

Here, such a malfunction can, for example, occur suddenly during a journey at high vehicle speed and/or sporadically. A malfunction or a failure of an environmental, by way of example image-generating, sensor, by way of example an image camera, can lead to the vehicle control system becoming blind, and/or to only incomplete fusion of the sensor signals or sensor data being possible.

This challenge can be met as follows. When a malfunction is identified or established the vehicle control system can initially attempt to prompt the driver of the vehicle with suitable means to guide the vehicle, so that the latter can again take over complete vehicle guidance. If the driver of the vehicle shows no sign of a response, the vehicle can be braked by the vehicle control system and brought to a halt until a response is detected, for example.

Where there is a high traffic density or market penetration of vehicles with autonomous vehicle guidance, however, the number of malfunctioning vehicles may rise. Where the driver of the vehicle does not comply with a vehicle takeover request, a health problem of the driver can further be concluded, which requires rapid medical assistance. If the vehicle comes to a halt on a freeway for example, the arrival of assistance may be delayed, however.

This challenge can be solved by the vehicle control system using an X-to-X and/or vehicle-to-vehicle communication in the environment of the vehicle to seek a guidance vehicle, where the driver of the vehicle does not comply with the vehicle takeover request.

As a lead vehicle, the guidance vehicle can take on the role of a substitute fallback level, and guide the vehicle to a point, a service area for example, where, by way of example, emergency services can gain access more easily. Accordingly, electronic towing of the vehicle by an unrelated guidance vehicle can be implemented.

Here the driver of the guidance vehicle contacted by the vehicle can confirm the role, the task, or the function of the electronically towing guidance vehicle. In this way irritations of the driver can be minimized. The driver of the guidance vehicle can further perform their role with an adapted way of driving.

Simultaneously with or parallel to the electronic towing process an emergency services control center can be contacted and/or informed, so that, by way of example, an emergency team can be sent in good time to the destination point to which the vehicle is being towed. This allows a rapid response from an emergency service.

So, if the driver of the vehicle does not comply with the vehicle takeover request, using an X-to-X and/or vehicle-to-vehicle communication the vehicle control system can search in the environment of the vehicle for a guidance vehicle, which as a lead vehicle can take on the role of substitute fallback level, and guide the vehicle to a point, a service area for example, where, by way of example, emergency services can gain access more easily. In this way, electronic towing of the vehicle by the guidance vehicle and rapid assistance by an emergency service can be implemented.

Vehicle-to-X communications is currently in a phase of development and standardization. This term is understood to mean in particular communication between vehicles (vehicle-to-vehicle communication) and communication between vehicles and infrastructure (vehicle-to-infrastructure communication).

The vehicle control system can be used for highly automated driving (HAD) of the vehicle. Here the vehicle control system can be implemented using a Vehicle-2-X (V2X) communication.

Detection of an environment of the vehicle can be implemented by means of sensors, for example RADAR sensors, image camera sensors, or LIDAR sensors. Using a fusion of sensor signals or sensor data from various sensors, more complex guidance functions, for example a roadworks assistant function or automatic emergency braking of the vehicle, can be implemented.

One aspect of the autonomous vehicle guidance is the fallback strategy in those cases where the vehicle control system cannot cope with the driving situation on its own, for example if a malfunction or a technical defect has occurred in the vehicle control system, and/or some of the sensor signals or sensor data is no longer available for the autonomous vehicle guidance.

One approach is to hand over driving responsibility, by way of example for steering, braking and accelerating, to the driver. Since the driver may be distracted, a vehicle takeover time ranging from a number of seconds to half a minute can be expected until the driver is actually able to take over the driving of vehicle.

If the driver intentionally or unintentionally fails to take over the vehicle guidance or vehicle control, the autonomously guided vehicle, by means of sensors for detecting the environment and/or a communications network, can link up virtually to a guidance vehicle travelling in front and be towed to the next available stopping place. This concept can be extended in a number of ways.

Activation of the guidance or towing mode can be indicated in the vehicle and/or in the guidance vehicle optically and/or acoustically, so that the driver concerned and any passengers concerned are made aware of the situation. They can then take measures extending beyond the automated functions of the vehicle and/or of the guidance vehicle, waking up a driver, or calling an emergency response physician for example.

The guidance or towing mode can be based on a residual functionality of the autonomous vehicle guidance. This means that the guidance or towing mode can be implemented using some of the sensors for detecting the environment of the vehicle. By way of example, the vehicle can follow the guidance vehicle, if the image cameras of the sensor technology for autonomous vehicle guidance have failed, but a RADAR sensor is still functioning. The vehicle control system for autonomous vehicle guidance, prior to the fallback to the guidance or towing mode, can analyze if the residual functionality of the vehicle is sufficient for this.

For the virtual guidance or towing of the vehicle by the guidance vehicle on the basis of the car-to-X (Car2X) communication, data redundancy on the environment of the vehicle can be taken into account.

The guiding or towing guidance vehicle can take handling characteristics of the guided or towed vehicle into account. In order to allow the vehicle to follow the guidance vehicle, a reduction in speed and/or an adaptation of the driving dynamics of the vehicle or of the guidance vehicles can be performed. This can be negotiated by the vehicle and the guidance vehicle via a communications link. Here the residual functionality of the guided or towed vehicle can be taken into account.

The guiding or towing guidance vehicle, in order to assist the guided or towed vehicle, can transmit local information on the environment of the vehicle and/or of the guidance vehicle to the guided or towed vehicle.

For the communication between the vehicle and the guidance vehicle various communication technologies, such as ITS-G5, LTE, WLAN, Bluetooth or UWB, can be used. The communications link between the vehicle and the guidance vehicle can be latency-free, stable and/or allow authentication.

Accordingly, a fallback level for the autonomous vehicle guidance can be implemented, which can reduce the number of accidents and/or traffic holdups.

Alternatively, the vehicle control system for autonomous vehicle guidance, in the event of a malfunction or a defect or failure by the driver to take over responsibility for driving, can perform automatic braking to a halt of the vehicle.

The foregoing preferred embodiments have been shown and described for the purposes of illustrating the structural and functional principles of the present invention, as well as illustrating the methods of employing the preferred embodiments and are subject to change without departing from such principles. Therefore, this invention includes all modifications encompassed within the scope of the following claims.

1. A vehicle control system for autonomously guiding a vehicle comprising:
a controller for autonomously guiding the vehicle on the basis of a sensor signal of a sensor of the vehicle, wherein the controller is designed to detect a malfunction of the sensor of the vehicle;
a communications interface, which in response to the detection of the malfunction of the sensor by the controller, requests an auxiliary sensor signal via a communications network and to receive the requested auxiliary sensor signal via the communications network; and
wherein the controller is designed to autonomously guide the vehicle on the basis of the received auxiliary sensor signal.

2. The vehicle control system of to claim 1, wherein the controller has a sensor interface for receiving the sensor signal and can detect the malfunction of the sensor of the vehicle in the absence of receipt of the sensor signal.

3. The vehicle control system of claim 1, wherein the communications interface sends a request the auxiliary sensor signal via the communications network from a guidance vehicle and to receive the auxiliary sensor signal via the communications network from the guidance vehicle.

4. The vehicle control system of claim 1, wherein the controller detects a plurality of geographical locations of a plurality of vehicles in the environment of the vehicle and to select a guidance vehicle from the plurality of vehicles on the basis of the plurality of geographical locations.

5. The vehicle control system of claim 4, wherein the communications interface receives a plurality of location indicators via the communications network, wherein the plurality of location indicators indicate the plurality of geographical locations of the plurality of vehicles, and wherein the controller detects the plurality of geographical locations on the basis of the plurality of location indicators.

6. The vehicle control system of claim 1, wherein the communications interface receives a driving route indicator from a guidance vehicle via the communications network, wherein the driving route indicator indicates a driving route of the guidance vehicle, and wherein the controller autonomously determines a driving route of the vehicle on the basis of the driving route indicator.

7. The vehicle control system of claim 1, wherein the controller detects a severity of the malfunction of the sensor, in order to obtain a malfunction severity indicator, and wherein the communications interface transmits the malfunction severity indicator via the communications network together with the request for the auxiliary sensor signal.

8. The vehicle control system of to claim 1, wherein the communications interface establishes an authenticated or encrypted communications link via the communications network, in particular between the vehicle and a guidance vehicle.

9. The vehicle control system of to claim 1, wherein the vehicle comprises an additional sensor, and wherein the controller autonomously guides the vehicle on the basis of an additional sensor signal of the additional sensor of the vehicle.

10. The vehicle control system of to claim 1, wherein the controller in response to the detection of the malfunction of the sensor, generates a malfunction indicator, indicating the malfunction of the sensor, and wherein the communications interface transmits the malfunction indicator via the communications network to a back-end server.

11. The vehicle control system of to claim 1, wherein in the sensor signal or the auxiliary sensor signal comprises one of: a RADAR sensor signal, a LIDAR sensor signal, an ultrasound sensor signal, and an image camera sensor signal.

12. The vehicle control system of to claim 1, wherein the communications interface comprises one of: an ITS-G5 communications interface, a mobile radio communications interface, a WLAN communications interface, a Bluetooth communications interface, and a UWB communications interface.

13. A method for autonomously guiding a vehicle comprising:
autonomously guiding of the vehicle on the basis of a sensor signal of a sensor of the vehicle;
detecting of a malfunction of the sensor of the vehicle;
requesting an auxiliary sensor signal via a communications network in response to the detection of the malfunction of the sensor;
receiving the requested auxiliary sensor signal via the communications network; and
autonomously guiding the vehicle on the basis of the received auxiliary sensor signal.

14. The method according to claim 13, wherein the auxiliary sensor signal is requested via the communications network from a guidance vehicle, and wherein the auxiliary sensor signal is received via the communications network from the guidance vehicle.

15. A vehicle control system comprising:
a communications interface;
a controller having a computer program with a program code with instructions for:
autonomously guiding of the vehicle on the basis of a sensor signal of a sensor of the vehicle;
detecting of a malfunction of the sensor of the vehicle;
requesting an auxiliary sensor signal via a communications network in response to the detection of the malfunction of the sensor;
receiving the requested auxiliary sensor signal via the communications network; and
autonomously guiding the vehicle on the basis of the received auxiliary sensor signal.

16. The vehicle control system of claim 15, wherein the auxiliary sensor signal is requested via the communications network from a guidance vehicle, and wherein the auxiliary sensor signal is received via the communications network from the guidance vehicle.
